(19) United States
(12) Patent Application Publication
(10) Pub. No.: US 2018/0328296 A1
(43) Pub. Date: Nov. 15, 2018

(54) VEHICLE CONTROL APPARATUS

(71) Applicant: TOYOTA JIDOSHA KABUSHIKI KAISHA, Toyota-shi (JP)

(72) Inventor: Hiroyuki HAGA, Numazu-shi (JP)

(73) Assignee: TOYOTA JIDOSHA KABUSHIKI KAISHA, Toyota-shi (JP)

(21) Appl. No.: 15/975,381

(22) Filed: May 9, 2018

(30) Foreign Application Priority Data
May 12, 2017 (JP) 2017-095709

(51) Int. Cl. F02D 41/00; F01N 3/00

(52) U.S. Cl. CPC F02D 41/0047; F01N 3/005; F01N 2570/22; F02D 2200/501; F02D 2200/701

(57) ABSTRACT

Provided is a vehicle control apparatus for controlling a vehicle including an internal combustion engine and an own-vehicle position detection device. The internal combustion engine includes a plurality of cylinders arranged so as to be aligned along the width direction of the vehicle, and an EGR device equipped with an EGR channel configured to connect an exhaust channel with a portion of an intake channel located on the upstream side of a branch portion to the plurality of cylinders. The vehicle control apparatus includes a controller programmed, when a condensed water occurrence condition is met and when predicting turning of the vehicle based on information from the own-vehicle position detection device, to execute a misfire countermeasure process to reduce or avoid misfire, for at least a cylinder located outermost during the turning among the plurality of cylinders, during at least a part of time of the turning.

### CROSS-REFERENCE TO RELATED APPLICATION

This application is based on and claims the benefit of Japanese Patent Application No. 2017-095709, filed on May 12, 2017, which is incorporated by reference herein in its entirety.

### BACKGROUND

### Technical Field

The present disclosure relates to a vehicle control apparatus, and more particularly to a vehicle control apparatus for controlling a vehicle equipped with an internal combustion engine in which a part of exhaust gas flowing through an exhaust channel is introduced, as an EGR gas, into an intake channel via an EGR channel.

### Background Art

For example, JP 2013-019315 A discloses an intake system structure of an internal combustion engine that includes an EGR device. This EGR device is equipped with an EGR chamber that includes an internal channel that serves as an EGR channel. Exhaust gas (EGR gas) is distributed into intake branch channels of the individual cylinders from the EGR chamber via an exhaust gas distribution channels provided for the individual cylinders. In the EGR chamber, condensed water may be generated. A rib for restricting movement of the condensed water in the direction of arrangement of the exhaust gas distribution channels is provided on the inner wall surface of the EGR chamber.

According to the technique disclosed in JP 2013-019315 A, even if the condensed water generated inside the EGR chamber is affected by the lateral acceleration or longitudinal acceleration produced due to turning or acceleration/deceleration of the vehicle, the inflow of the condensed water can be prevented from being biased towards a specified cylinder, misfire can thus be reduced.

However, in the intake system structure disclosed in JP 2013-019315 A, since it is required to provide the rib on the inner wall surface of the EGR chamber, there is a concern that cost of the intake system structure may increase. Therefore, it is favorable that, contrary to the countermeasures disclosed in JP 2013-019315 A, countermeasures against the misfire that should be taken when an intensive inflow of the condensed water to the specified cylinder may be generated due to turning or acceleration/deceleration of the vehicle are made by improvement of the vehicle control apparatus.

### SUMMARY

The present disclosure has been made to address the problem described above, and an object of the present disclosure is to provide a vehicle control apparatus that can reduce or avoid misfire in a condition in which an intensive inflow of condensed water to a specified cylinder may be generated due to turning or acceleration/deceleration of the vehicle.

A vehicle control apparatus according to one aspect of the present disclosure is configured to control a vehicle that includes an internal combustion engine and an own-vehicle position detection device configured to detect a position of the vehicle on a road.

The internal combustion engine includes a plurality of cylinders arranged so as to be aligned along a width direction of the vehicle, and an EGR device equipped with an EGR channel configured to connect an exhaust channel with a portion of an intake channel located on an upstream side of a branch portion to the plurality of cylinders.

The vehicle control apparatus includes a controller, the controller being programmed, when a condensed water occurrence condition in which condensed water occurs in at least one of the EGR channel and the portion of the intake channel located on the upstream side of the branch portion is met, and when predicting turning of the vehicle based on information from the own-vehicle position detection device, to execute a misfire countermeasure process to reduce or avoid misfire, for at least a cylinder located outermost during the turning among the plurality of cylinders, during at least a part of time of the turning.

The controller may execute the misfire countermeasure process when the condensed water occurrence condition is met and when predicting the turning of the vehicle during which a lateral acceleration greater than or equal to a certain value continuously acts on the vehicle over a certain time period.

The misfire countermeasure process may be an EGR decrease process to control the EGR device such that an amount of EGR gas that flows through the intake channel decreases.

The misfire countermeasure process may be an EGR decrease process to control the EGR device such that an amount of EGR gas that flows through the intake channel decreases. Also, the controller may start the EGR decrease process at a timing earlier than a timing at which the lateral acceleration reaches the certain value.

The internal combustion engine may include an actuator used in control of an engine control parameter that affects combustion stability of the internal combustion engine. Also, the misfire countermeasure process may be a combustion stability improvement process to correct the engine control parameter so as to improve the combustion stability.

The vehicle may be a hybrid vehicle that includes, as its power source, an electric motor as well as the internal combustion engine. Also, the misfire countermeasure process may be a power change process to stop operation of the internal combustion engine and to control the electric motor so as to compensate for a decrease of a vehicle running torque accompanied by a stop of the internal combustion engine.

A vehicle control apparatus according to another aspect of the present disclosure is configured to control a vehicle that includes an internal combustion engine and an own-vehicle position detection device configured to detect a position of the vehicle on a road.

The internal combustion engine including a plurality of cylinders arranged so as to be aligned along a front-rear direction of the vehicle, and an EGR device equipped with an EGR channel configured to connect an exhaust channel with a portion of an intake channel located on an upstream side of a branch portion to the plurality of cylinders,

The vehicle control apparatus comprising a controller, the controller being programmed, when a condensed water occurrence condition in which condensed water occurs in at least one of the EGR channel and the portion of the intake channel located on the upstream side of the branch portion is met, and when predicting acceleration or deceleration of the vehicle based on information from the own-vehicle position detection device, to execute a misfire countermeasure process to reduce or avoid misfire, for at least a specified end cylinder among the plurality of cylinders, during at least a part of time of the acceleration or deceleration, wherein the specified end cylinder is a cylinder that is located on a rear-most side in the front-rear direction during the acceleration and located on a most-front side in the front-rear direction during the deceleration.

The controller may execute the misfire countermeasure process when the condensed water occurrence condition is met and when predicting the acceleration or deceleration of the vehicle during which a longitudinal acceleration greater than or equal to a certain value continuously acts on the vehicle over a certain time period.

The misfire countermeasure process may be an EGR decrease process to control the EGR device such that an amount of EGR gas that flows through the intake channel decreases.

The misfire countermeasure process may be an EGR decrease process to control the EGR device such that an amount of EGR gas that flows through the intake channel decreases. Also, the controller may start the EGR decrease process at a timing earlier than a timing at which the longitudinal acceleration reaches the certain value.

The internal combustion engine may include an actuator used in control of an engine control parameter that affects combustion stability of the internal combustion engine. Also, the misfire countermeasure process may be a combustion stability improvement process to correct the engine control parameter so as to improve the combustion stability.

The vehicle may be a hybrid vehicle that includes, as its power source, an electric motor as well as the internal combustion engine. Also, the misfire countermeasure process may be a power change process to stop operation of the internal combustion engine and to control the electric motor so as to compensate for a decrease of a vehicle running torque accompanied by a stop of the internal combustion engine.

According to the vehicle control apparatus of one aspect of the present disclosure, misfire can be reduced or avoided in a condition in which an intensive inflow of condensed water to a specified cylinder may be generated due to turning of the vehicle. Also, According to the vehicle control apparatus of another aspect of the present disclosure, misfire can be reduced or avoided in a condition in which an intensive inflow of condensed water to a specified cylinder may be generated due to acceleration/deceleration of the vehicle.

### BRIEF DESCRIPTION OF THE DRAWINGS

FIG. 1 is a diagram for describing a system configuration of a vehicle according to a first embodiment of the present disclosure;

FIG. 2 is a diagram for describing a configuration of an internal combustion engine shown in FIG. 1;

FIG. 3 is a graph that illustrates an example of differences between the amounts of condensed water that flows into individual cylinders during the turning of the vehicle;

FIG. 4 is a graph that illustrates an example of a condensed water amount map that defines a relationship between the condensed water amount (occurrence amount) and an engine operating region;

FIG. 5 is a time chart for describing an execution timing of a misfire countermeasure process (EGR decrease process) executed in the first embodiment of the present disclosure;

FIG. 6 is a flow chart that illustrates a routine of processing concerning an engine control according to the first embodiment of the present disclosure;

FIG. 7 is a flow chart that illustrates a routine of processing concerning an engine control according to a second embodiment of the present disclosure;

FIG. 8 is a diagram for describing a system configuration of a vehicle according to a third embodiment of the present disclosure;

FIG. 9 is a flow chart that illustrates a routine of processing concerning a vehicle control according to the third embodiment of the present disclosure; and

FIG. 10 is a diagram for describing a system configuration of a vehicle according to a fourth embodiment of the present disclosure.

### DETAILED DESCRIPTION

In the following, embodiments of the present disclosure are described with reference to the accompanying drawings. However, it is to be understood that even when the number, quantity, amount, range or other numerical attribute of an element is mentioned in the following description of the embodiments, the present disclosure is not limited to the mentioned numerical attribute unless explicitly described otherwise, or unless the present disclosure is explicitly specified by the numerical attribute theoretically. Further, structures or steps or the like that are described in conjunction with the following embodiments are not necessarily essential to the present disclosure unless explicitly shown otherwise, or unless the present disclosure is explicitly specified by the structures, steps or the like theoretically.

### First Embodiment

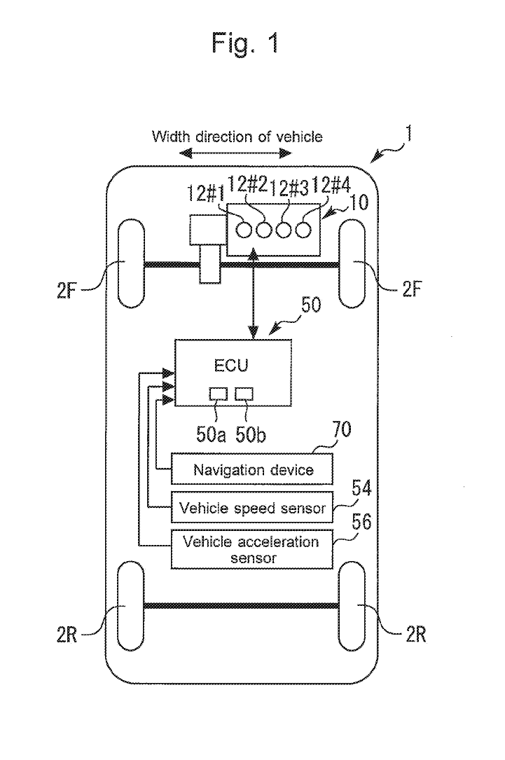

First, a first embodiment according to the present disclosure will be described with reference to FIGS. 1 to 6.

### 1. System Configuration of Vehicle According to First Embodiment

FIG. 1 is a diagram for describing a system configuration of a vehicle 1 according to the first embodiment of the present disclosure. As an example, the vehicle 1 shown in FIG. 1 is a four-wheel vehicle equipped with two front wheels 2F and two rear wheels 2R. An internal combustion engine 10 is mounted on the vehicle 1 as its power source.

### 1-1. Manner of Mounting Internal Combustion Engine

The internal combustion engine 10 is an in-line four cylinder engine that includes four cylinders 12#1 to 12#4. As shown in FIG. 1, the internal combustion engine 10 is mounted on the vehicle 1 such that these four cylinders 12#1 to 12#4 are aligned along the width direction of the vehicle 1. It should be noted that an alternative internal combustion engine having a different number of cylinders and different arrangement thereof other than the example of the in-line four cylinder type may be used, as far as it includes a plurality of cylinder arranged so as to be aligned along the width direction of the vehicle 1.

### 1-2. Example of Configuration of Internal Combustion Engine

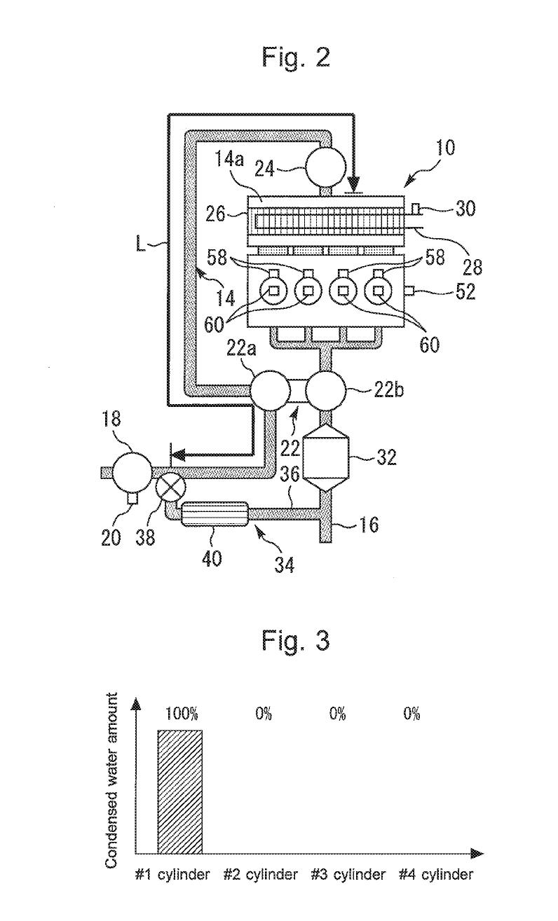

FIG. 2 is a diagram for describing a configuration of the internal combustion engine 10 shown in FIG. 1. As an example, the internal combustion engine 10 is a spark-ignition type internal combustion engine. An intake channel 14 and an exhaust channel 16 communicate with the individual cylinders 12#1 to 12#4 of the internal combustion engine 10.

### 1-2-1. Configuration Around Intake and Exhaust Channels

An air cleaner 18 is provided in the vicinity of an inlet of the intake channel 14. An air flow sensor 20 that outputs a signal responsive to the flow rate Ga of air (fresh air) taken into the intake channel 14 is attached to the air cleaner 18.

The internal combustion engine 10 is provided with a turbo-supercharger 22 as one example of a supercharger for supercharging intake air. In a portion of the intake channel 14 located on the downstream side of the air cleaner 18, a compressor 22a of the turbo-supercharger 22 is installed.

In a portion of the intake channel 14 located on the downstream side of the compressor 22a, an electronically controlled throttle valve 24 is arranged. An intake manifold 14a is provided on the downstream side of the throttle valve 24. A channel in the intake manifold 14a serves as a part of the intake channel 14.

In a collective portion (a surge tank) of the intake manifold 14a, an intercooler 26 for cooling intake gas compressed by the compressor 22a is installed. The intercooler 26 is of a water-cooled type, and includes a water pump and a radiator that are not shown in the drawings, as well as a cooling water flow channel 28 (only a part of which is illustrated in FIG. 2). To be more specific, the intercooler 26 is configured such that cooler-cooling water that is lower in temperature than engine cooling water for cooling an engine main body (at least including a cylinder block) circulates through the cooling water flow channel 28. Moreover, a cooler water temperature sensor 30 that outputs a signal responsive to the temperature of the cooler-cooling water that flows through the inside of the cooling water flow channel 28 is attached thereto. It should be noted that the intercooler 26 may be arranged on the upstream side of the throttle valve 24, instead of the example described above.

In the exhaust channel 16, a turbine 22b of the turbo-supercharger 22 is installed. An upstream-side catalyst 32 and a downstream-side catalyst (not shown in the drawings) are installed in series in the exhaust channel 16 at portions located on the downstream side of the turbine 22b in order to purify exhaust gas.

### 1-2-2. EGR Device

The internal combustion engine 10 shown in FIG. 2 is provided with an EGR device 34. The EGR device 34 includes an EGR channel 36, an EGR valve 38 and an EGR cooler 40. The EGR channel 36 connects the exhaust channel 16 with the intake channel 14 at a portion located on the upstream side of the intercooler 26. In more detail, the EGR channel 36 connects the intake channel 14 at a portion located on the upstream side of the compressor 22a with the exhaust channel 16 at a portion located on the downstream side of the turbine 22b. That is, the EGR device 34 is of a low pressure loop (LPL) type. In further addition to this, the EGR channel 36 is connected to the exhaust channel 16 at the portion between the upstream-side catalyst 32 and the downstream-side catalyst mentioned above. The EGR valve 38 is, as an example, electrically driven, and is installed in the EGR channel 36 to open and close the EGR channel 36. The EGR cooler 40 is of a water-cooled type, and cools EGR gas that flows through the EGR channel 36.

Since, if the EGR valve 38 is closed, the EGR gas is not introduced into the intake channel 14, intake air thus corresponds to “intake gas” that passes through the compressor 22a. If, on the other hand, the EGR valve 38 is open, mixed gas of the intake air (fresh air) and the EGR gas corresponds to the “intake gas” that passes through the compressor 22a. According to the EGR device 34 described above, the flow rate of the EGR gas that flows through the EGR channel 36 is controlled with adjustment of the opening degree of the EGR valve 38 and, as a result, an EGR rate can be controlled. The EGR rate refers to the ratio of the amount of the EGR gas with respect to the amount of the intake gas (the mixed gas described above) that flows into the cylinders. In further addition to this, according to the EGR device 34, the EGR gas is introduced into a portion of the intake channel 14 located on the upstream side of a branch portion to four cylinders 12#1 to 12#4.

### 1-3. Configuration of Control System

Furthermore, the vehicle 1 is equipped with an electric control unit (ECU) 50 as shown in FIG. 1. Various sensors installed in the internal combustion engine 10 and the vehicle 1 on which the internal combustion engine 10 is mounted, various actuators for controlling the operation of the internal combustion engine 10 and a navigation device 70 installed in the vehicle 1 are electrically connected to the ECU 50.

The ECU 50 includes a processor 50a, a memory 50b, and an input/output interface. The input/output interface receives sensor signals from the various sensors described above, and outputs actuating signals to the various actuators described above. In the memory 50b, various control programs and maps for controlling the various actuators are installed. The processor 50a reads out a control program from the memory and executes the control program. Thus, a function of the “vehicle control apparatus” according to the present embodiment is achieved.

### 1-3-1. Sensors

The various sensors described above include a crank angle sensor 52 (see FIG. 2), a vehicle speed sensor 54 and a vehicle acceleration sensor (G-force sensor) 56 as well as the air flow sensor 20 and the cooler water temperature sensor 30 that are described above. The crank angle sensor 52 outputs a signal responsive to a crank angle of the internal combustion engine 10. The ECU 50 can obtain an engine speed by the use of the crank angle sensor 52. The vehicle speed sensor 54 outputs a vehicle speed signal responsive to the vehicle speed (vehicle body speed). The vehicle acceleration sensor 56 is configured to be able to output an acceleration signal responsive to each of the lateral acceleration (lateral G-force) that is acceleration rate in the right and left direction of the vehicle 1 and the longitudinal acceleration (longitudinal G-force) that is acceleration rate in the front-rear direction thereof.

### 1-3-2. Actuators

The various actuators described above include fuel injection valves 58 and an ignition device 60 as well as the throttle valve 24 and the EGR valve 38 described above. The fuel injection valves 58 are, for example, in-cylinder injection valves which are provided for the respective cylinders, and each of which directly injects fuel into the cylinder. The ignition device 60 uses a spark plug provided for each cylinder to ignite an air-fuel mixture in each cylinder.

### 1-3-3. Navigation Device

The navigation device 70 is configured so as to be able to obtain the current position of the vehicle 1 on the road map by the use of, for example, a GPS (Global Positioning System). In more detail, the navigation device 70 can select a running path (a predicated path) from the current position of the vehicle 1 to a desired destination. In addition, information on curves on the road (including intersections) is included in road information stored in the navigation device 70. Therefore, according to the navigation device 70, based on the current position of the vehicle 1 and the road information concerning the predicated path, the arrival of a curve can be predicted and the information (such as, a curvature radius) of a curve located ahead of the vehicle 1 in the direction of travel can be obtained. This navigation device 70 corresponds to an example of the “own-vehicle position detection device” according to the present disclosure.

### 2. Problem on Occurrence of Condensed Water

### 2-1. Occurrence of Condensed Water

In order to improve the thermal efficiency of the internal combustion engine 10, it is effective to increase the EGR rate. However, during the EGR gas being introduced into the intake channel 14, if the mixed gas of the fresh air and the EGR gas is cooled in the intercooler 26 to its dew point or lower of the mixed gas, condensed water is generated inside the intercooler 26. Also, if a large amount of the EGR gas is introduced associated with an increase of the EGR rate, the amount of the condensed water that is generated becomes greater.

### 2-2. Effects of Condensed Water on Combustion During Turning of Vehicle

The intercooler 26 is arranged on the upstream side of the branch portion of the intake channel 14 (the intake manifold 14a) to the individual cylinders 12. Thus, the condensed water generated in the intercooler 26 is basically distributed equally to the individual cylinders 12 along with the intake gas. However, there is the following exception to this.

Specifically, during the turning of the vehicle 1, the centrifugal force towards the outside of the turning, that is, the lateral G-force acts on each part of the vehicle 1. The lateral G-force is also affected by condensed water that is generated in the intercooler 26 and that flows through the intake channel 14 along with the intake gas. In more detail, in the vehicle 1, the cylinders 12#1 to 12#4 are arranged so as to be aligned along the width direction of the vehicle 1. Thus, if the lateral G-force is affected by the condensed water that flows through the intake channel 14, the amount of inflow of the condensed water to the individual cylinders 12 is biased towards the cylinder 12 located outside during the turning. In other words, the amount of the inflow of the condensed water to the individual cylinders 12 becomes greater at a cylinder closer to the end on the outside during the turning.

FIG. 3 is a graph that illustrates an example of differences between the amounts of the condensed water that flows into the individual cylinders 12 during the turning of the vehicle 1. FIG. 3 represents an example in which a great lateral G-force is generated during the turning of the vehicle 1 (more specifically, during the turning in which the cylinder 12#1 is located outside). If a great lateral G-force is continuously generated during the turning, the inflow of the condensed water is biased, to a great extent, towards a cylinder located outside during the turning. Also, if this kind of biased inflow of the condensed water is generated to a greater extent due to the occurrence of a greater lateral G-force, the condensed water intensively flows into a specified one cylinder (that is, the cylinder 12#1 or 12#4 located outermost during the turning).

If the condensed water flows into the cylinders 12, the flame propagation is disturbed by the condensed water and there is the possibility that the number of cycles in which combustion becomes unstable including misfire may increase. Also, if, the amount of inflow of the condensed water to the individual cylinders 12 is biased as a result of the turning as described above, misfire (more specifically, misfire that continuously occurs in a plurality of combustion cycles (i.e., consecutive misfire)) becomes likely to occur.

### 3. Engine Control According to First Embodiment in Condensed Water Occurrence Condition

In view of the problem described above, in the present embodiment, when a condensed water occurrence condition in which condensed water is generated in the intercooler 26 is met and it is predicted that the vehicle 1 turns in such a way that a lateral G-force that is greater than or equal to a certain value Gth continuously acts on the vehicle 1 over a certain time period Tth, the following control is performed. That is, a misfire countermeasure process for reducing misfire is performed during the turning with respect to, as an example, all the cylinders 12.

### 3-1. Determination Method of Condensed Water Occurrence Condition

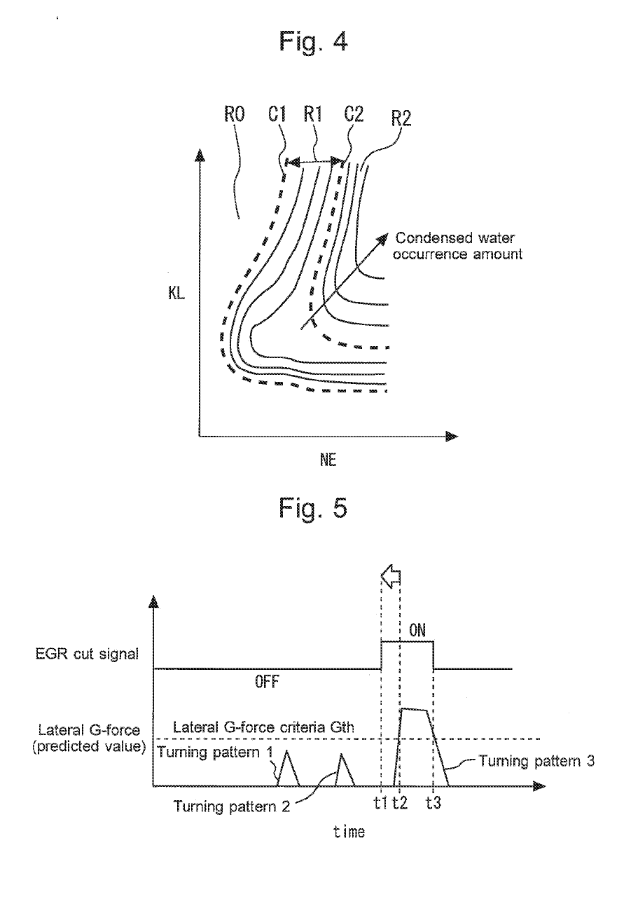

FIG. 4 is a graph that illustrates an example of a condensed water amount map that defines a relationship between the condensed water amount (occurrence amount) and the engine operating region. The engine operating region is identified by an engine load (more specifically, a load factor) and an engine speed as shown in FIG. 4. As a premise, EGR rates at the respective engine operating points in the engine operating region are stored in a base EGR rate map (not shown) that defines a relationship between the engine load and the engine speed, and the base EGR rates. The amount of the condensed water generated in the intercooler 26 in each operating point during introduction of the EGR gas can be obtained by experiment or simulation and represented as in the example shown in FIG. 4.

The individual curved lines including curved lines C1 and C2 in FIG. 4 correspond to equal-condensed-water-amount lines. The curved line C1 corresponds to a boundary about whether or not the condensed water is generated in the engine operating region. To be more specific, the condensed water is not generated in an operating region R0 located on the side lower in engine load and engine speed than the curved line C1, while the condensed water is generated in operating regions R1 and R2 on the side higher in engine load and engine speed than the curved line C1 or on the curved line C1.

Although the amount of the condensed water at each engine operating point varies depending on the EGR rate which is used, it roughly becomes greater when the engine load and the engine speed are higher as shown in FIG. 4. The operating region R2 located on the side higher in engine load and engine speed than the curbed line C2 corresponds to such an operating region that, if the total amount of the condensed water that has occurred flows into one cylinder 12 intensively, misfire occurs surely. On the other hand, the operating region R1 located on the side lower in engine load and engine speed than the curved line C2 or on the curved line C2 corresponds to such an operating region that, although the condensed water is generated, misfire does not always occur even if the intensive inflow of the condensed water described above occurs. As just described, the curved line C2 corresponds to a boundary for isolating the operating region R2 in which misfire surely occurs when an intensive inflow of the condensed water to a specified one cylinder 12 occurs intensively, from the operating region R1 in which misfire does not always occur.

In the ECU 50, a condensed water amount map having a relationship as shown in FIG. 4 is stored. Because of this, the amount of the condensed water at the current engine load KL and engine speed NE can be obtained from the condensed water amount map during introduction of the EGR gas. Accordingly, in the present embodiment, if the current engine operating point is in the operating region R0 of the condensed water amount map (that is, if the amount of the condensed water is zero), it is determined that the condensed water occurrence condition is not met. If, on the other hand, the current engine operating point is in the operating region R1 or R2 (that is, if the amount of the condensed water is greater than zero), it is determined that the condensed water occurrence condition is met. In other words, in the present embodiment, whether or not the condensed water occurrence condition is met changes depending on whether or not the engine operating point exceeds the curved line C1. It should be noted that the condensed water occurrence map may be determined such that the individual map values differ from each other in accordance with the intake air temperature.

### (Other Example of Determination on Condensed Water Occurrence Condition)

A boundary of whether or not the condensed water occurrence condition is met may not be the curved line C1 but an arbitrary equal-condensed-water-amount line in the operating region R1 (that is, a line located between the curved line C1 and the curved line C2). In further addition to this, if an equal condensed water amount line near the curved line C1 is selected as a boundary, the frequency of execution of the misfire countermeasure process increases, and misfire can thus be reduced due to an intensive inflow of the condensed water on many occasions. If, on the other hand, an equal-condensed-water-amount line near the curved line C2 is selected as a boundary, the frequency of execution of the misfire countermeasure process can be reduced to a minimum necessary frequency for reduction of consecutive misfire. Also, if this equal condensed water amount line near the curved line C2 is selected, a decrease of number of executions of EGR gas introduction can be suppressed to a minimum necessary when a decrease in amount of the EGR gas is used as the misfire countermeasure process as in the example of the present embodiment, and fuel efficiency improvement effect by EGR gas introduction can be ensured more effectively.

### 3-2. Prediction Method of Lateral G-Force

In the present embodiment, in order to predict the magnitude of the lateral G-force generated during the turning of the vehicle 1 and its generation time period while associating them with the position of the vehicle 1 on the road, the navigation device 70 is used. Specifically, during running of the vehicle 1, the ECU 50 executes a learning process of lateral G-force information by the use of the navigation device 70, the vehicle speed sensor 54 and the vehicle acceleration sensor 56. This learning process is executed to measure the lateral G-force information of each curve on the road map and stores it in the ECU 50. One example of this kind of prediction information of the lateral G-force is a waveform (time-series data) of the lateral G-force associated with the position of the vehicle 1 on the road. With respect to curves through which the vehicle 1 has already passed, an average value (average waveform) of measured values of a plurality of lateral G-force waveforms may be, for example, used as stored values of the lateral G-force waveform (for example, waveforms as represented in turning patterns 1 to 3 in FIG. 5 described later). It should be noted that, instead of the lateral G-force information described above, the prediction information of the lateral G-force may alternatively be, for example, a maximum value of the lateral G-force during the turning and the time of the turning in which the lateral G-force having a magnitude that is greater than or equal to the certain value Gth described later continuously acts on the vehicle 1. Furthermore, the learning process of the lateral G-force may alternatively be performed with selection of curves whose curvature radius is smaller than or equal to a certain value (that is, curves at which a greater lateral G-force is easy to be generated).

When a curve for which the learning of the lateral G-force information described above has already been done comes ahead of the vehicle 1 in the direction of travel, the ECU 50 reads out the lateral G-force waveform (a learned value) at a “prediction execution position” before the entrance of this curve and uses it as a prediction waveform of the lateral G-force. Thus, before the vehicle 1 approaches the curve, it becomes possible to predict the magnitude of the lateral G-force at each time point during the turning of this curve and its generation time period.

### 3-3. Misfire Countermeasure Process According to First Embodiment (EGR Decrease Process)

In the present embodiment, as described above, when the condensed water occurrence condition is met and it is predicted that the vehicle 1 turns in such a way that a lateral G-force that is greater than or equal to the certain value Gth continuously acts on the vehicle 1 over the certain time period Tth, the misfire countermeasure process is executed during the turning. In detail, the misfire countermeasure process according to the present embodiment corresponds to an “EGR decrease process” that controls the EGR device 34 such that the amount of the EGR gas that flows through the intake channel 14 decreases. It should be noted that this kind of EGR decrease process corresponds to an example in which the misfire countermeasure process is executed with respect to all the cylinders.

To be more specific, in the EGR decrease process according to the present embodiment, as an example, the EGR valve 38 is fully closed to stop introduction of the EGR gas. The certain value Gth of the lateral G-force corresponds to a lower limit value of the lateral G-force in which an intensive inflow of the condensed water to one cylinder 12 is generated due to the turning. The certain time period Tth corresponds to a lower limit value of the time of the turning in which the aforementioned intensive inflow of the condensed water is generated under the lateral G-force that is greater than or equal to the certain value Gth.

FIG. 5 is a time chart for describing an execution timing of the misfire countermeasure process (EGR decrease process) executed in the first embodiment of the present disclosure. Operation shown in FIG. 5 is premised on the condensed water occurrence condition. In FIG. 5, waveforms of the lateral G-force generated during the turning of three curves on the road (that is, turning patterns 1 to 3) are represented.

The turning patterns 1 and 2 in FIG. 5 correspond to examples of turning during which the lateral G-force (the turning G-force) does not reach the certain value (lateral G-force criteria) Gth. In the examples of the turning patterns 1 and 2, even when the condensed water occurrence condition is met, the EGR decrease process is not executed. On the other hand, the turning pattern 3 corresponds to an example of turning in which the lateral G-force exceeds the certain value Gth and the time of the turning is longer than the certain time period Tth. In the example of the turning pattern 3, the EGR decrease process is executed as far as the condensed water occurrence condition is met.

(Start Timing of EGR Decrease Process with Response Delay of EGR Gas Taken into Consideration)

A time point t2 in FIG. 5 corresponds to a timing at which the lateral G-force reaches the certain value Gth in the example of the turning pattern 3. The EGR decrease process executed as the misfire countermeasure process may alternatively be started at this time point t2. However, in the present embodiment, the start timing of the EGR decrease process is more advanced than the time point t2 with the following point taken into consideration.

A symbol “L” shown in FIG. 2 indicates the length of the intake channel 14 from the introduction portion of the EGR gas to the inlet of the intercooler 26. Due to the presence of an intake channel volume of a portion indicated by this length L, there is a delay from the closing of the EGR valve 38 as a result of output of an EGR cut signal until the amount of the EGR gas actually decreases at the position of the intercooler 26. Thus, if the EGR decrease process is started at the time point t2 without this intake channel volume taken into consideration, condensed water derived from the EGR gas present in this intake channel volume is generated at the intercooler 26.

Accordingly, in order to more sufficiently decrease the amount of the condensed water that intensively flows into a specified cylinder during the lateral G-force being generated, it is favorable to advance the start timing of the EGR decrease process (i.e., a timing at which the EGR cut signal is made) with the above-described response delay of the EGR gas taken into consideration. A time point t1 in FIG. 5 corresponds to a timing at which the issuance of the EGR cut signal is more advanced than the time point t2 by a response delay time of the EGR gas. In the present embodiment, the EGR decrease process is started so as not to be delayed as compared to this kind of time point t1.

Moreover, the EGR decrease process is continuously performed until a time point t3 at which the lateral G-force falls below the certain value Gth. In other words, in the example shown in FIG. 5, the EGR decrease process (misfire countermeasure process) is executed during a part of the time of the turning. It should be noted that, contrary to this example, a margin for the execution time period of the EGR decrease process may be greater. In more detail, the EGR decrease process may be continuously executed, for example, until the vehicle 1 finishes passing through a curve subject to the EGR decrease process (in other words, over the whole time period during the turning).

In further addition to this, the above-described response delay time of the EGR gas can be calculated on the basis of the intake channel volume and the intake air flow rate Ga that are described above. This intake channel volume is a known value, and the intake air flow rate Ga can be obtained by the use of, for example, the air flow sensor 20. The less the intake air flow rate Ga is, the longer this response delay time becomes. Because of this, it is favorable to change the time point t1 in FIG. 5 in accordance with the response delay time of the EGR gas (i.e., the intake air flow rate Ga). Accordingly, in the present embodiment, the start timing of the EGR decrease process is more advanced than the time point t2 when the intake air flow rate Ga is greater. Moreover, the “prediction execution position” of the lateral G-force information has a margin for being able to properly addressing a change of the start timing of the EGR decrease process with the response delay of the EGR gas taken into consideration. Furthermore, with the time point t1 made variable in accordance with the response delay time of the EGR gas as just described, it becomes possible to control the stop time for the EGR gas introduction by the EGR decrease process to the minimum necessary. In other words, since the time of introduction of the EGR gas can be secured as long as possible, it is favorable to make this kind of time point t1 variable in terms of improvement of the fuel efficiency.

### 3-4. Processing of ECU Concerning Engine Control According to First Embodiment in Condensed Water Occurrence Condition

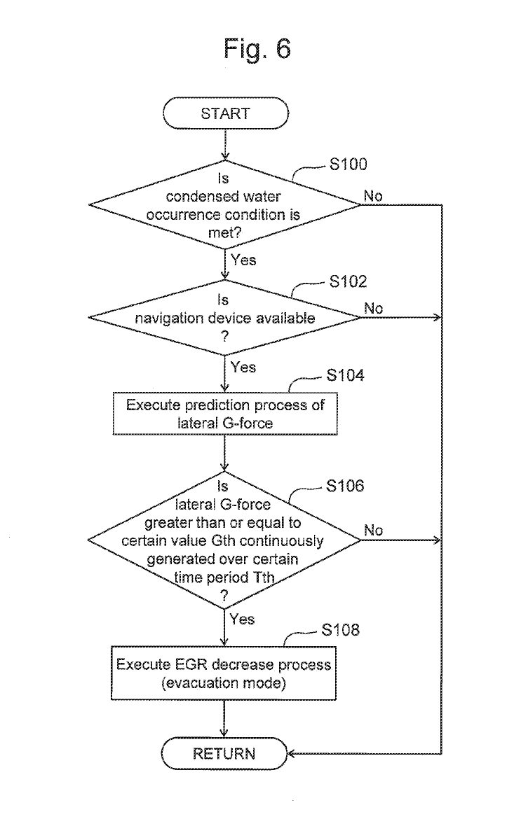

FIG. 6 is a flow chart that illustrates a routine of the processing concerning the engine control according to the first embodiment of the present disclosure. It should be noted that the present routine is repeatedly executed at a predetermined control interval during an “EGR introduction operation” in which the EGR gas is introduced into the cylinders.

In the routine shown in FIG. 6, first, the ECU 50 determines whether or not the condensed water occurrence condition is met (step S100). In this step S100, whether or not the condensed water occurrence condition is met is determined, for example, by the use of the condensed water amount map described above with reference to FIG. 4. It should be noted that, instead of the manner using this kind of map, whether or not the condensed water occurrence condition is met may alternatively be determined, on the basis of, for example, whether or not a calculated dew point of the intake gas (i.e., the mixed gas of the fresh air and the EGR gas) that passes through the intercooler 26 is higher than the temperature of the intercooler 26. In addition, for example, the temperature of the cooler-cooling water detected by the use of the cooler water temperature sensor 30 is substituted for the temperature of the intercooler 26. Furthermore, for example, the amount of occurrence of the condensed water may be actually calculated on the basis of certain parameters, and it may alternatively be determined that, when a calculated amount of occurrence of the condensed water is greater than or equal to a certain value, the condensed water occurrence condition is met.

If the condensed water occurrence condition is not met in step S100, the ECU 50 promptly ends the processing of the routine currently in progress. If, on the other hand, the condensed water occurrence condition is met, the ECU 50 then determines whether or not the navigation information of the navigation device 70 is available (step S102).

If the ECU 50 determines in step S102 that the navigation device 70 is not available, it promptly ends the processing of the routine currently in progress. If, on the other hand, the ECU 50 determines that the navigation device 70 is available, it proceeds to step S104.

In step S104, a prediction process concerning the lateral G-force information on a curve subject to prediction (hereunder, also referred to as a “prediction target curve”) that is located ahead of the vehicle 1 in the direction of travel is executed. In more detail, the lateral G-force waveform (i.e., prediction waveform) during the turning of the current prediction target curve is obtained from the learning data of the prediction target curve for the own vehicle. If the lateral G-force waveform is found, the magnitude of the lateral G-force during the turning is found. Furthermore, in another example in which the lateral G-force exceeds the certain value Gth, by the use of an obtained lateral G-force information, a time point at which the lateral G-force reaches the certain value Gth during the turning and a time point at which the lateral G-force falls below the certain value Gth thereafter can be calculated in association with the position of the vehicle 1 on the road. That is, the time of the turning during which a lateral G-force that exceeds the certain value Gth continuously acts on the vehicle 1 can be calculated in association with the position thereof.

In addition, in order to be able to address a change of the start timing of the EGR decrease process with the above-described response delay time of the EGR gas taken into consideration, the prediction process with respect to each prediction target curve by this step S104 is executed at a position before the entrance of each curve subject to prediction with a margin (i.e., the prediction execution position). Thus, even if there are a series of prediction target curves, the prediction for each curve can be performed at a timing that is advanced so as to be able to address the response delay of the EGR gas.

Next, the ECU 50 determines, concerning the prediction target curve located immediately ahead of the vehicle 1, whether or not a lateral G-force that is greater than or equal to the certain value Gth continuously acts on the vehicle 1 over the certain time period Tth (step S106). As a result, if the determination result of step S106 is negative, that is, if it can be judged that the condensed water does not flow into a specified one cylinder 12#1 or 12#4 intensively, the ECU 50 promptly ends the processing of the routine currently in progress.

If the determination result of step S106 is positive, that is, if it is predicted that the condensed water flows into a specified one cylinder 12#1 or 12#4 intensively, the ECU 50 executes the EGR decrease process, as an evacuation mode (fail-safe mode), in such a manner as to cancel the introduction of the EGR gas (step S108). As a result of this, the EGR cut signal for fully closing the EGR valve 38 is issued towards the EGR device 34.

### 4. Advantageous Effects of Engine Control According to First Embodiment in Condensed Water Occurrence Condition

According to the processing of the routine shown in FIG. 6 described so far, when the condensed water occurrence condition is met and it is predicted that the vehicle 1 turns in such a way that a lateral G-force that is greater than or equal to the certain value Gth continuously acts on the vehicle 1 over the certain time period Tth, the EGR decrease process, as the misfire countermeasure process, is executed during the turning. Thus, even in a condition in which the condensed water may intensively flow into the specified cylinder 12#1 or 12#4 due to the turning, the occurrence of the condensed water at the intercooler 26 is reduced and, as a result, the inflow of the condensed water into the cylinder 12#1 or 12#4 can be reduced. As a result, in a condition in which an intensive inflow of the condensed water to the specified cylinder 12#1 or 12#4 due to the turning of the vehicle 1 may be generated, engine control (misfire countermeasure process) that can reduce misfire (more specifically, consecutive misfire at the specified cylinder 12#1 or 12#4) can be achieved.

In further addition to this, according to the processing of the routine described above, the prediction process of step S104 is executed when the vehicle 1 reaches a position before the entrance of the prediction target curve with the above-described response delay time of the EGR gas taken into consideration. Then, the EGR decrease process is promptly executed after the determination result of step S106 that is executed without delay from an execution timing of this prediction process becomes positive. That is, the EGR decrease process is started at a timing earlier than a timing at which the lateral G-force reaches the certain value Gth. Thus, the turning of the vehicle 1 can be stared while securing a margin time for decreasing the amount of the EGR gas in the intake gas that flows through the intercooler 26 that is an occurrence portion of the condensed water. In more detail, according to the routine described above, in order to secure a favorable margin time, the execution timings of the prediction process and the EGR decrease process are determined such that the time from the start of the EGR decrease process until the lateral G-force reaches the certain value Gth becomes longer than the time required to eliminate the response delay of the EGR gas. Therefore, prior to approaching a curve subject to execution of the EGR decrease process, the EGR rate at a portion of the intake channel 14 identified with the length L described above (see FIG. 2) can be reduced (in the example of the present routine, the EGR rate can be made zero).

In contrast to the manner according to the present embodiment, it is also conceivable to execute the EGR decrease process on the basis of the detection results of the lateral G-force that is actually generated by the use of, for example, the vehicle acceleration sensor 56. However, there is the possibility that, if the EGR decrease process is started after the lateral G-force greater than or equal to the certain value Gth is detected as in this example, condensed water derived from the EGR gas present in the intake channel volume described above in this start time point may intensively flow into the specified one cylinder 12#1 or 12#4. On the other hand, according to the processing of the present routine, the misfire countermeasure process can be executed while also avoiding an intensive inflow of the condensed water generated due to the response delay of the EGR gas.

### 4. Other Example of EGR Decrease Process

In the first embodiment described above, as an example of the EGR decrease process, the EGR valve 38 is fully closed to make zero the amount of the EGR gas. However, the EGR decrease process may not always be executed as in the example described above and the amount of the EGR gas may be controlled such that the EGR rate other than zero is obtained, as far as the amount of the EGR gas that flows through the intake channel 14 is caused to decrease.

### 5. Other Prediction Method of Lateral G-Force

In the example of the prediction method explained in the first embodiment described above, the learned values of the lateral G-force information based on the running records of the own vehicle are used. However, prediction of the lateral G-force information may not always be performed as in the example described above, and may alternatively be performed as follows, for example.

### 5-1. Example of Utilization of Running Information of Other Vehicles

One of other prediction methods is to utilize running information of other vehicles. Specifically, as a premise, the ECU 50 is assumed to be configured to be able to communicate with an external server (not shown) that statistically obtains and manages the running information of other vehicles (that may include running information of the own vehicle). Moreover, the running information managed by this external server is assumed to include a statistical information (big data) of the lateral G-force information (for example, the lateral G-force information) concerning each curve on the road map. The ECU 50 may alternatively be configured so as to communicate with the external server at the above-described “prediction execution position” to obtain the lateral G-force information.

5-2. Example of Vehicle in which Automated Driving Control is Performed

Another example of other prediction methods is premised on a vehicle (not shown) that includes an ECU capable of executing automated driving control (more specifically, automated steering control and automated acceleration/deceleration control). If this kind of the automated driving control is in execution, the ECU can grasp, in advance, an approaching speed to a curve located on a target running path of the vehicle, a vehicle speed during the turning and the steering angle of a steering wheel. Because of this, at the “prediction execution position” described above, the ECU can calculate, in advance, the lateral G-force information (for example, the lateral G-force waveform) generated during the turning, on the basis of these approaching speed and the steering angle, and the information on the curve obtained from the navigation device 70. Thus, in a vehicle in which the automated driving control is performed, the ECU may alternatively use the above-descried calculation values of the lateral G-force as those predict values.

### Second Embodiment

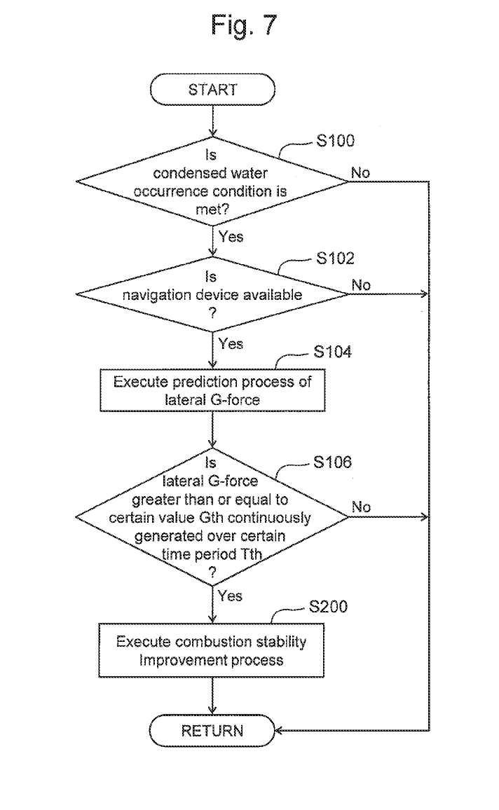

Next, a second embodiment according to the present disclosure will be described with reference to FIG. 7.

### 1. System Configuration According to Second Embodiment

In the following description, it is assumed that the configuration shown in FIGS. 1 and 2 is used as an example of the system configuration according to the second embodiment.

### 2. Engine Control According to Second Embodiment in Condensed Water Occurrence Condition

### 2-1. Misfire Countermeasure Process According to Second Embodiment (Combustion Stability Improvement Process)

Engine control according to the second embodiment is different from the engine control according to the first embodiment in terms of the misfire countermeasure process. To be more specific, in the present embodiment, a “combustion stability improvement process” is executed as the misfire countermeasure process. The internal combustion engine 10 is equipped with the ignition device 60 that is an actuator for controlling a spark timing that is one example of engine control parameters that affect the combustion stability. The combustion stability improvement process corresponds to a process for correcting the spark timing so as to improve the combustion stability with respect to the cylinder 12#1 or 12#4 located outermost during the turning of the vehicle 1 (more specifically, a process for controlling the ignition device 60 such that the spark timing is advanced). The combustion stability improvement process is continuously executed until at least the lateral G-force falls below the certain value Gth.

### 2-2. Processing of ECU Concerning Engine Control According to Second Embodiment in Condensed Water Occurrence Condition

FIG. 7 is a flow chart that illustrates a routine of the processing concerning the engine control according to the second embodiment of the present disclosure. The processing of steps S100 to S106 in the routine shown in FIG. 7 is as already described in the first embodiment.

In the routine shown in FIG. 7, if the determination result of step S106 is positive, that is, if it is predicted that the condensed water intensively flows into a specified one cylinder 12, the ECU 50 executes the combustion stability improvement process (step S200).

Specifically, in step S200, first, the ECU 50 determines which of the cylinders 12#1 and 12#4 is a cylinder located outermost when the vehicle 1 turns a curve subject to the current combustion stability improvement process. This determination can be performed by, for example, obtaining information of the shape of the curve by the use of the navigation device 70.

On that basis, the combustion stability improvement process is executed, during the turning, with respect to the cylinder 12#1 or 12#4 that has been determined as a cylinder located outermost during the turning. In more detail, in the ECU 50, a map (not shown) that defines a relationship between the base control amount of the spark timing and engine operating conditions (for example, engine load and engine speed) is stored. In the combustion stability improvement process, the spark timing of the cylinder 12#1 or 12#4 located outermost is corrected so as to advance with respect to the base control amount depending on the engine operating conditions.

### 2-3. Advantageous Effects of Engine Control According to Second Embodiment in Condensed Water Occurrence Condition

According to the processing of the routine shown in FIG. 7 described so far, when the condensed water occurrence condition is met and it is predicted that the vehicle 1 turns in such a way that a lateral G-force that is greater than or equal to the certain value Gth continuously acts on the vehicle 1 over the certain time period Tth, the combustion stability improvement process is executed, during the turning, with respect to the cylinder 12#1 or 12#4 located outermost during the turning. According to the combustion stability improvement process, in a condition in which the condensed water may intensively flow into the specified cylinder due to the turning, the spark timing of the cylinder 12#1 or 12#4 located outermost that corresponds to this specified cylinder is advanced and the combustion stability is improved. Therefore, according to this kind of misfire countermeasure process, misfire can also be reduced in a condition in which the condensed water may intensively flow into the specified cylinder 12#1 or 12#4 due to the turning of the vehicle 1.

### 3. Other Examples of Engine Control Parameters for Combustion Stability Improvement Process

In the second embodiment described above, the spark timing is taken as an example of engine control parameters which are controlled so as to improve the combustion stability. However, this kind of engine control parameters may not always be the spark timing, and may be spark energy or fuel injection amount, for example. In addition, control of a plurality of the engine control parameters which are utilized may arbitrary be combined with each other.

To be more specific, in an example in which the spark energy is used instead of the spark timing, the ECU 50 may control the ignition device 60 so as to increase the spark energy (that is, so as to improve the combustion stability). Also, in an example in which the fuel injection amount is used instead of the spark timing, the ECU 50 may control the fuel injection valve 58, which is an example of another actuator used for the control of an engine control parameter that affects the combustion stability, such that the fuel injection amount increases (that is, so as to improve the combustion stability). It should be noted that the spark energy can be increased by, for example, charging a condenser after completion of discharge and thereafter discharging again. Alternatively, if a plurality of ignition coil are provided, the spark energy can be increased by increasing the number of ignition coils to be used for discharging.

### 4. Another Example of Cylinders Subject to Combustion Stability Improvement Process

In the second embodiment described above, one or more cylinders directed to the combustion stability improvement process is exemplified by only the cylinder 12#1 or 12#4 located outermost. However, the combustion stability improvement process may alternatively be executed with respect to not only the cylinder 12#1 or 12#4 but also other one or more cylinders, as far as it is executed with respect to at least a cylinder located outermost during the turning. In more detail, as described above, it is favorable that, since the condensed water intends to intensively flow into a cylinder located outermost during the turning, additional one or more cylinders directed to the combustion stability improvement process are located near the cylinder located outermost. In addition, if the combustion stability improvement process is executed with respect to a plurality of cylinders as just described, the amount of correction of the engine control parameters, such as the spark timing, may be made greater at a cylinder closer to the end on the outside during the turning.

### 5. Example of Selectively Executing Misfire Countermeasure Processes According to First and Second Embodiments

If a large amount of condensed water in the operating region R2 of the condensed water amount map shown in FIG. 4 intensively flows into one cylinder 12#1 or 12#4, it is difficult for the combustion stability improvement process corresponding to the misfire countermeasure process according to the second embodiment to surely reduce misfire. In contrast to this, the EGR decrease process corresponding to the misfire countermeasure process according to the first embodiment decreases, prior to approaching the turning, the amount of the EGR gas that is a cause of occurrence of the condensed water. It can therefore be said that, in a condition in which a large amount of the condensed water in the operating region R2 is generated, the EGR decrease process is superior to the combustion stability improvement process. On the other hand, it can be said that, if the amount of the condensed water that flows into one cylinder 12#1 or 12#4 is small and misfire can be reduced sufficiently by the combustion stability improvement process, the combustion stability improvement process which is not required to stop introduction of the EGR gas is superior to the EGR decrease process.

Accordingly, the EGR decrease process and the combustion stability improvement process may be selectively executed in a manner as described below. That is, for example, if the determination result of step S106 is positive in the condensed water occurrence condition in which condensed water of amount identified by the operating region R2 shown in FIG. 4 is generated, the ECU 50 may execute the EGR decrease process. Also, if, on the other hand, the determination result of step S106 is positive in the condensed water occurrence condition in which condensed water of amount identified by the operating region R1 is generated, the ECU 50 may execute the combustion stability improvement process. Alternatively, if, for example, the vehicle 1 is during the turning in which a lateral G-force that is greater than or equal to the certain value Gth continuously acts on the vehicle 1 over the certain time period Tth (that is, if the determination result of step S106 is positive), the ECU 50 may execute the EGR decrease process, and, on the other hand, if, although the condensed water occurrence condition is met, the determination result of step S106 is negative (that is, if the inflow of the condensed water to the specified cylinder is biased to a small extent), the ECU 50 may execute the combustion stability improvement process. It should be noted that a “power change process” according to a third embodiment described below and the combustion stability improvement process according to the second embodiment may be combined with each other similarly to the example described above.

### Third Embodiment

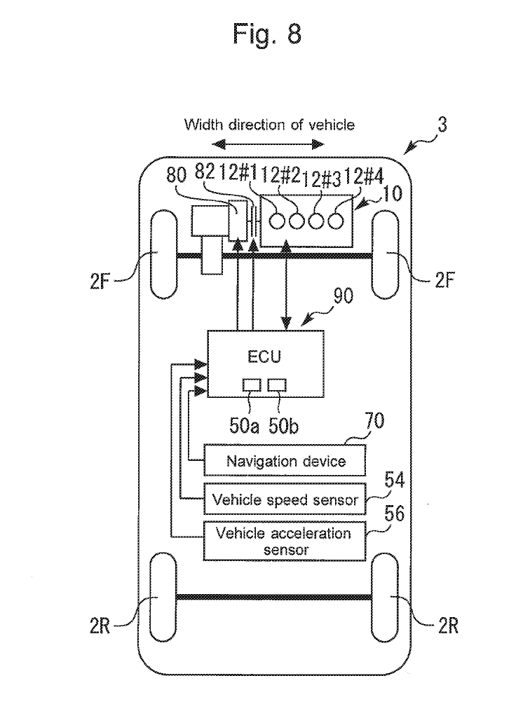

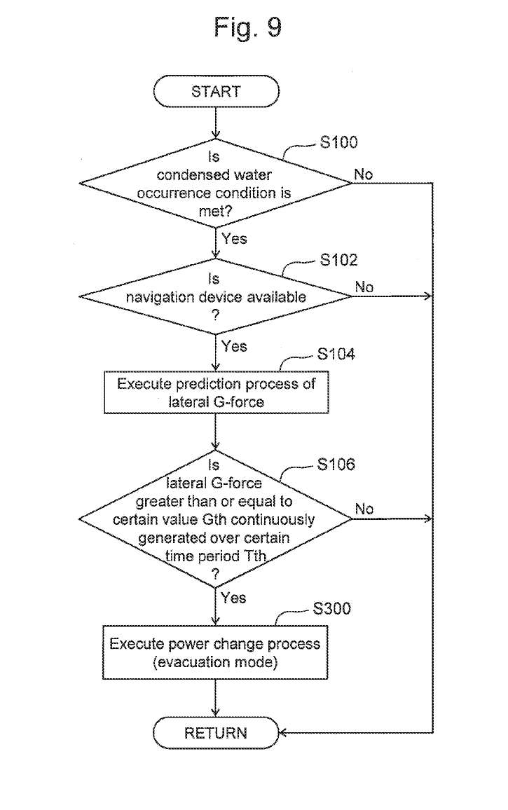

Next, a third embodiment according to the present disclosure will be described with reference to FIGS. 8 and 9.

### 1. System Configuration of Vehicle According to Third Embodiment

FIG. 8 is a diagram for describing a system configuration of a vehicle 3 according to the third embodiment of the present disclosure. In addition, in FIG. 8, elements that are the same as constituent elements illustrated in FIG. 1 described above are denoted by the same reference symbols, and a description of those elements is omitted or simplified hereunder.

The vehicle 3 shown in FIG. 8 is a hybrid vehicle equipped with, as its power source, an electric motor 80 in addition to the internal combustion engine 10 shown in FIG. 2. As with the vehicle 1, the internal combustion engine 10 is mounted on this vehicle 3 such that four cylinders 12#1 to 12#4 are aligned along the width direction of the vehicle 3.

Also, the vehicle 3 is equipped with a clutch 82 located between the internal combustion engine 10 and the electric motor 80. As an example, the clutch 82 is of a hydraulic type. In the vehicle 3, when the clutch 82 is engaged, only the driving force of the internal combustion engine 10, or the resultant force of the driving force of the internal combustion engine 10 and the driving force of the electric motor 80 can be transmitted to the front wheels 2F. On the other hand, when the clutch 80 is disengaged, it is possible to transmit only the driving force of the electric motor 80 to the front wheels 2F.

Furthermore, in the vehicle 3, an ECU 90 is provided as shown in FIG. 8. Various sensors, various actuators and the navigation device 70 are electrically connected to the ECU 90 as with the ECU 50. The electric motor 80 and the clutch 82 described above are also electrically connected to the ECU 90. Thus, the ECU 90 controls not only the operation of the internal combustion engine 10 but also the entire power train of the vehicle 3.

### 2. Vehicle Control According to Third Embodiment in Condensed Water Occurrence Condition

### 2-1. Misfire Countermeasure Process According to Third Embodiment (Power Change Process)

The engine control according to the present embodiment is different from the engine control according to each of the first and second embodiments in terms of the misfire countermeasure process. Specifically, in the present embodiment, the “power change process” is executed as the misfire countermeasure process. According to the power change process, at a timing earlier than a timing at which the lateral G-force reaches the certain value Gth, the operation of the internal combustion engine 10 is stopped and the electric motor 80 is controlled so as to compensate a decrease of the vehicle running torque accompanied by the stop of the internal combustion engine 10. The power change process is continuously executed until at least the lateral G-force falls below the certain value Gth. It should be noted that this kind of power change process corresponds to an example in which the misfire countermeasure process is executed with respect to all the cylinders.

### 2-2. Processing of ECU Concerning Vehicle Control According to Third Embodiment in Condensed Water Occurrence Condition

FIG. 9 is a flow chart that illustrates a routine of the processing concerning the vehicle control according to the third embodiment of the present disclosure. The processing of steps S100 to S106 in the routine shown in FIG. 9 is as already described in the first embodiment.

In the routine shown in FIG. 9, if the determination result of step S106 is positive, that is, if it is predicted that the condensed water intensively flows into a specified one cylinder 12#1 or 12#4, the ECU 50 executes the power change process as the evacuation mode (fail-safe mode) (step S300).

Specifically, in this step S300, in response to the prediction by the processing of step S106, the fuel injection to the internal combustion engine 10 is stopped to stop the operation of the internal combustion engine 10, at a timing earlier than the entrance of the vehicle 1 into the prediction target curve (which corresponds to an example of a timing earlier than a timing at which the lateral G-force reaches the certain value Gth). Then, the electric motor 80 is controlled so as to compensate a decrease of the vehicle running torque accompanied by the stop of the internal combustion engine 10. In more detail, if the vehicle 3 runs by the use of only the driving force of the internal combustion engine 10 before execution of the power change process, the ECU 90 starts the operation of the electric motor 80 so as to compensate a decrease of the vehicle running torque. On the other hand, if the vehicle 3 runs by the use of the driving force of the electric motor 80 as well as the driving force of the internal combustion engine 10 before the power change process, the ECU 90 increases the torque of the electric motor 80 so as to cause it to produce a torque for compensating elimination of the engine torque. It should be noted that, in order to reduce the occurrence of a torque shock accompanied by the execution of the power change process, it is favorable to gradually increase the motor torque while gradually decreasing the engine torque.

### 2-3. Advantageous Effects of Vehicle Control According to Third Embodiment in Condensed Water Occurrence Condition

According to the processing of the routine shown in FIG. 9 described so far, when the condensed water occurrence condition is met and it is predicted that the vehicle 3 turns in such a way that a lateral G-force that is greater than or equal to the certain value Gth continuously acts on the vehicle 3 over the certain time period Tth, the power change process described above is executed before the vehicle 3 approaches the prediction target curve (that is, before the vehicle 3 starts the turning of the prediction target curve). Thus, before the lateral G-force greater than or equal to the certain value Gth continuously acts on the vehicle 3, the flow of the intake gas in the intake channel 14 can be stopped as a result of the stop of the operation of the internal combustion engine 10. According to this kind of misfire countermeasure process, misfire can be avoided in a condition in which an intensive inflow of the condensed water to the specified cylinder 12#1 or 12#4 may be generated due to the turning of the vehicle 3. Moreover, since the electric motor 80 is controlled so as to compensate a decrease of the vehicle running torque accompanied by the stop of the operation of the internal combustion engine 10, the misfire countermeasure can be performed without decreasing of the running performance of the vehicle 3.

### 3. Example of Other Type of Hybrid Vehicle

In contrast to the vehicle 3 that includes a configuration shown in FIG. 8, the power change process according to the third embodiment described above can also be applied to, for example, a hybrid vehicle that includes a configuration in which, when the operation of an internal combustion engine is stopped and the vehicle running is performed by the use of only an electric motor, the internal combustion engine during stop of its operation is driven to rotate by the use of the electric motor. In an example of this hybrid vehicle, although the flow of the intake gas in an intake channel is not stopped even if the operation of the internal combustion engine is stopped by the power change process, misfire can be similarly reduced since the operation of the internal combustion engine is stopped.

### Fourth Embodiment

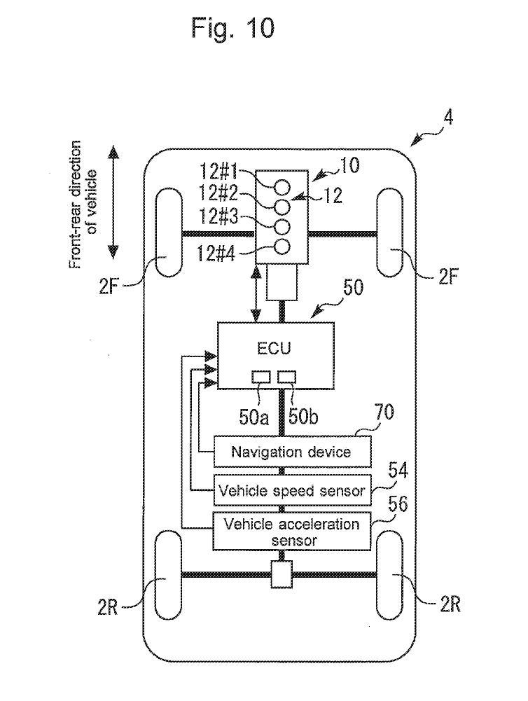

Next, a fourth embodiment according to the present disclosure will be described with reference to FIG. 10.

### 1. System Configuration of Vehicle According to Fourth Embodiment

### 1-1. Manner of Mounting Internal Combustion Engine

FIG. 10 is a diagram for describing a system configuration of a vehicle 4 according to the fourth embodiment of the present disclosure. In addition, in FIG. 10, elements that are the same as constituent elements illustrated in FIG. 1 described above are denoted by the same reference symbols, and a description of those elements is omitted or simplified hereunder.

The vehicle 4 according to the present embodiment is different from the vehicle 1 or 3 according to the first to third embodiments in the mounting manner of the internal combustion engine 10. That is, as shown in FIG. 10, the internal combustion engine 10 is mounted on the vehicle 4 such that its four cylinders 12#1 to 12#4 are aligned along the front-rear direction of the vehicle 4.

### 2. Problem on Occurrence of Condensed Water

In a vehicle, as with the vehicles 1 and 3, on which an internal combustion engine is mounted such that a plurality of cylinders are aligned along the width direction of the vehicle, as described above, an intensive inflow of the condensed water to the specified cylinder may be generated during the turning due to the influence of the lateral G-force. In contrast to this, in the vehicle 4 on which the internal combustion engine 10 is mounted such that the plurality of cylinders 12#1 to 12#4 are aligned along the front-rear direction of the vehicle 4, an intensive inflow of the condensed water to the specified cylinder may be generated during acceleration or deceleration. In more detail, during the acceleration in which (positive) acceleration rate acts on the vehicle 4, the inflow of the condensed water is easy to be biased towards a cylinder located on the rear-most side of the vehicle 4 in the front-rear direction (in the example shown in FIG. 10, the cylinder 12#4 corresponds to this). On the other hand, during the deceleration in which deceleration rate (negative acceleration rate) acts on the vehicle 4, the inflow of the condensed water is easy to be biased towards a cylinder located on the most-front side of the vehicle 4 in the front-rear direction (in the example shown in FIG. 10, the cylinder 12#1 corresponds to this). It should be noted that the cylinder 12#4 during the acceleration and the cylinder 12#1 during the deceleration correspond to the “specified end cylinder” according to the present disclosure.

### 3. Engine Control According to Fourth Embodiment in Condensed Water Occurrence Condition

In the present embodiment, in order to reduce or avoid misfire accompanied by a biased inflow of the condensed water to a specified cylinder (i.e., the specified end cylinder described above) that may be generated during the acceleration or deceleration, the misfire countermeasure process (EGR decrease process) described in the first embodiment is executed associated with the acceleration and deceleration of the vehicle 4 (more specifically, during at least a part of time of the acceleration or deceleration).

Specifically, similarly to the example according to the first embodiment in which the waveform of a predicted lateral G-force is obtained associated with the turning, the ECU 50 can obtain a waveform of the longitudinal acceleration (i.e., longitudinal G-force) of the vehicle 4 in association with the acceleration, by the use of the navigation device 70, the vehicle speed sensor 54 and the vehicle acceleration sensor 56, at a desired position on the road map. Also, if this kind of waveform of the longitudinal acceleration can be obtained, before the vehicle 4 reaches a position at which it is predicted that the longitudinal acceleration with this waveform is actually generated, it can be predicted, when the vehicle 4 passes through this position, whether or not a longitudinal G-force (absolute value) that is greater than or equal to the certain value Gth continuously acts on the vehicle 4 over the certain time period Tth due to the acceleration or deceleration of the vehicle 4. Thus, in the present embodiment, processing similar to the processing of the routine shown in FIG. 6 in the first embodiment is executed associated with the acceleration and deceleration of the vehicle 4 while utilizing this kind of prediction process. In further addition to this, as in the first embodiment, the EGR decrease process according to the present embodiment is also stated at a timing earlier than a timing at which the longitudinal acceleration reaches the certain value Gth.

According to the engine control of the fourth embodiment described so far, even if the condensed water may intensively flow into the specified end cylinder 12#1 or 12#4 due to the acceleration or deceleration of the vehicle 4, the intensive inflow of the condensed water to the specified end cylinder 12#1 or 12#4 can be reduced by reducing the occurrence of the condensed water in the intercooler 26. Also, other advantageous effects similar to those of the first embodiment can be achieved.

### 4. Execution of Other Misfire Countermeasure Process

In the vehicle 4 on which the internal combustion engine 10 is mounted such that the plurality of cylinders 12#1 to 12#4 are aligned along the front-rear direction of the vehicle 4, the misfire countermeasure process associated with the acceleration and deceleration may not always be the EGR decrease process described above, and may be one of the misfire countermeasure processes described in the second and third embodiments with respect to the turning. Specifically, processing similar to the processing of the routine shown in FIG. 7 in the second embodiment may alternatively be executed associated with the acceleration/deceleration of the vehicle 4. That is, during the acceleration or deceleration of the vehicle 4, the combustion stability improvement process may be executed for at least the “specified end cylinder”. In addition, for example, processing similar to the processing of the routine shown in FIG. 9 in the third embodiment may alternatively be executed associated with the acceleration/deceleration of a hybrid vehicle obtained by combining the electric motor 80 with the internal combustion engine 10 of the vehicle 4. That is, during the acceleration or deceleration of the vehicle 4, the power change process may be executed.

### Other Embodiments

### (Other Execution Condition Concerning Misfire Countermeasure Process)

In the first to third embodiments described above, the respective misfire countermeasure condition are executed when the condensed water occurrence condition is met and it is predicted that the vehicle 1 or 3 turns in such a way that a lateral G-force that is greater than or equal to the certain value Gth continuously acts on the vehicle 1 or 3 over the certain time period Tth. However, the biased inflow itself of the condensed water to the specified cylinder during the turning may be generated even when a lateral G-force that is greater than or equal to the certain value Gth does not continuously act on the vehicle 1 or 3 over the certain time period Tth. Thus, the misfire countermeasure process may not always be executed accompanied by the determination on the magnitude of the lateral G-force. That is, when the condensed water occurrence condition is met and the turning of a vehicle is predicted, the misfire countermeasure process may be executed, for at least a cylinder located outermost during the turning among a plurality of cylinders, during at least a part of the time of the turning. This also applies similarly to a misfire countermeasure process with respect to a vehicle in which a biased inflow of the condensed water to the specified cylinder may be generated due to the longitudinal G-force during the acceleration or deceleration as with the vehicle 4 according to the fourth embodiment.

(Example of Occurrence Portion of Condensed Water Other than Intercooler)

In the first to fourth embodiments described above, the misfire countermeasure process with respect to the condensed water generated in the intercooler 26 is taken as an example. However, even in a portion other than the intercooler 26, if condensed water is generated in at least one of an EGR channel and a portion of an intake channel located on the upstream side of a branch portion to a plurality of cylinders, an intensive inflow of the condensed water to the specified cylinder may be generated due to the influence of the lateral G-force or the longitudinal G-force of the vehicle. Therefore, the misfire countermeasure process may alternatively be directed to, for example, condensed water generated in a portion (such as, the EGR cooler 40) of the EGR channel 36 or condensed water generated in a portion of the intake channel 14 that is located on the upstream side of the aforementioned branch portion and other than the intercooler 26.

The embodiments and modifications described above may be combined in other ways than those explicitly described above as required and may be modified in various ways without departing from the scope of the present disclosure.

What is claimed is:

1. A vehicle control apparatus for controlling a vehicle,
the vehicle including an internal combustion engine and an own-vehicle position detection device configured to detect a position of the vehicle on a road,
the internal combustion engine including a plurality of cylinders arranged so as to be aligned along a width direction of the vehicle, and an EGR device equipped with an EGR channel configured to connect an exhaust channel with a portion of an intake channel located on an upstream side of a branch portion to the plurality of cylinders,
the vehicle control apparatus comprising a controller, the controller being programmed, when a condensed water occurrence condition in which condensed water occurs in at least one of the EGR channel and the portion of the intake channel located on the upstream side of the branch portion is met, and when predicting turning of the vehicle based on information from the own-vehicle position detection device, to execute a misfire countermeasure process to reduce or avoid misfire, for at least a cylinder located outermost during the turning among the plurality of cylinders, during at least a part of time of the turning.

2. The vehicle control apparatus according to claim 1,
wherein the controller executes the misfire countermeasure process when the condensed water occurrence condition is met and when predicting the turning of the vehicle during which a lateral acceleration greater than or equal to a certain value continuously acts on the vehicle over a certain time period.

3. The vehicle control apparatus according to claim 1,
wherein the misfire countermeasure process is an EGR decrease process to control the EGR device such that an amount of EGR gas that flows through the intake channel decreases.

4. The vehicle control apparatus according to claim 2,
wherein the misfire countermeasure process is an EGR decrease process to control the EGR device such that an amount of EGR gas that flows through the intake channel decreases, and
wherein the controller starts the EGR decrease process at a timing earlier than a timing at which the lateral acceleration reaches the certain value.

5. The vehicle control apparatus according to claim 1,
wherein the internal combustion engine includes an actuator used in control of an engine control parameter that affects combustion stability of the internal combustion engine, and
wherein the misfire countermeasure process is a combustion stability improvement process to correct the engine control parameter so as to improve the combustion stability.

6. The vehicle control apparatus according to claim 1,
wherein the vehicle is a hybrid vehicle that includes, as its power source, an electric motor as well as the internal combustion engine, and
wherein the misfire countermeasure process is a power change process to stop operation of the internal combustion engine and to control the electric motor so as to compensate for a decrease of a vehicle running torque accompanied by a stop of the internal combustion engine.

7. A vehicle control apparatus for controlling a vehicle,
the vehicle including an internal combustion engine and an own-vehicle position detection device configured to detect a position of the vehicle on a road,
the internal combustion engine including a plurality of cylinders arranged so as to be aligned along a front-rear direction of the vehicle, and an EGR device equipped with an EGR channel configured to connect an exhaust channel with a portion of an intake channel located on an upstream side of a branch portion to the plurality of cylinders,
the vehicle control apparatus comprising a controller, the controller being programmed, when a condensed water occurrence condition in which condensed water occurs in at least one of the EGR channel and the portion of the intake channel located on the upstream side of the branch portion is met, and when predicting acceleration or deceleration of the vehicle based on information from the own-vehicle position detection device, to execute a misfire countermeasure process to reduce or avoid misfire, for at least a specified end cylinder among the plurality of cylinders, during at least a part of time of the acceleration or deceleration, wherein the specified end cylinder is a cylinder that is located on a rear-most side in the front-rear direction during the acceleration and located on a most-front side in the front-rear direction during the deceleration.

8. The vehicle control apparatus according to claim 7,
wherein the controller executes the misfire countermeasure process when the condensed water occurrence condition is met and when predicting the acceleration or deceleration of the vehicle during which a longitudinal acceleration greater than or equal to a certain value continuously acts on the vehicle over a certain time period.

9. The vehicle control apparatus according to claim 7,
wherein the misfire countermeasure process is an EGR decrease process to control the EGR device such that an amount of EGR gas that flows through the intake channel decreases.

10. The vehicle control apparatus according to claim 8,
wherein the misfire countermeasure process is an EGR decrease process to control the EGR device such that an amount of EGR gas that flows through the intake channel decreases, and
wherein the controller starts the EGR decrease process at a timing earlier than a timing at which the longitudinal acceleration reaches the certain value.

11. The vehicle control apparatus according to claim 7,
wherein the internal combustion engine includes an actuator used in control of an engine control parameter that affects combustion stability of the internal combustion engine, and
wherein the misfire countermeasure process is a combustion stability improvement process to correct the engine control parameter so as to improve the combustion stability.

12. The vehicle control apparatus according to claim 7,
wherein the vehicle is a hybrid vehicle that includes, as its power source, an electric motor as well as the internal combustion engine, and
wherein the misfire countermeasure process is a power change process to stop operation of the internal combustion engine and to control the electric motor so as to compensate for a decrease of a vehicle running torque accompanied by a stop of the internal combustion engine.
